(19) United States
(12) Patent Application Publication
(10) Pub. No.: US 2019/0381580 A1
(43) Pub. Date: Dec. 19, 2019

(54) Template Tool for Installing and Building a Facade

(71) Applicant: Chris Calvert, Gilbert, AZ (US)

(72) Inventor: Chris Calvert, Gilbert, AZ (US)

(21) Appl. No.: 16/010,397

(22) Filed: Jun. 15, 2018

(51) Int. Cl. B23B 49/02; E04F 21/18

(52) U.S. Cl. CPC B23B 49/02; E04F 13/14; E04F 21/18

(57) ABSTRACT

The invention involves an apparatus, comprising a template body 101 with a guide portion 110 wherein the guide portion 110 includes upper 111 and lower 112 guide portions, and a guide portion slot 113. The template body 101 includes a first and second countersink guide channels. The apparatus includes a first spacer coupled to the guide portion slot 113 in a repeatably removeable manner.

### BACKGROUND OF THE INVENTION

### Field of the Invention

This invention relates generally to construction tools.

### Description of the Related Art

There are many different materials used in modern building construction, such as cement panels. Cement panels are non-combustible, durable, and cost effective. Cement panels are often used as cladding for a building façade. An example of cement panels are manufactured by Eternit AG of Switzerland, and are often referred to as SWISS PEARL panels. The cement panels are often fastened to a support frame using fasteners, wherein the fastener extends through an opening formed through the cement panel.

One problem with cement panels, however, is their tendency to crack when not installed properly. As can be appreciated, cement material expands and contracts in response to the temperature. For example, cement material expends when heated and contracts when cooled. The expansion and contraction of the cement panel can cause stress, especially at locations proximate to the fasteners. The stress proximate to the fasteners is from the cement panel undesirably engaging the fastener. The cement panel is more likely to engage the fastener when the fastener is not centered through an opening extending through the cement panel. Further, the cement panel is less likely to engage the fastener when the fastener is centered through the opening extending through the cement panel. Hence, what is needed is a tool that allows the fastener to be extended through the center of the opening extending through the cement panel.

### BRIEF SUMMARY OF THE INVENTION

The present invention is directed to a template tool, which allows an opening to be formed through a work piece, such as a cement panel. The novel features of the invention are set forth with particularity in the appended claims. The invention will be best understood from the following description when read in conjunction with the accompanying drawings.

### BRIEF DESCRIPTION OF THE DRAWINGS

It should be noted that like reference characters are used throughout the various views of the Drawings.

FIGS. 1 and 2 are top and bottom views, respectively, of a template.

FIG. 3 is a side view of the template of FIGS. 1 and 2.

FIG. 4 is a cut-away side view of the template of FIGS. 1 and 2 taken along a cut-line 4-4 of FIG. 2.

FIG. 5 is a cut-away side view of the template of FIGS. 1 and 2 taken along a cut-line 5-5 of FIG. 2.

FIG. 6 is a perspective view of a drill guide.

FIG. 7 is a side view of the drill guide of FIG. 6.

FIG. 8 is a top view of the drill guide of FIG. 6.

FIG. 9 is a bottom view of the drill guide of FIG. 6.

FIG. 10 is a side view of the drill guide of FIG. 6 taken along a cut-line 10-10 of FIG. 8.

FIG. 11 is a top view of a façade.

FIG. 12 is a close-up view of the façade of FIG. 11 showing the template of FIGS. 1 and 2.

FIG. 13 is a close-up side view of the façade of FIG. 11, with the template of FIGS. 1 and 2 positioned thereon, wherein a cement panel is to be coupled to a support member.

FIG. 14 is a cut-away side view of the cement panel of FIG. 13 and template taken along a cut-line 4-4 of FIG. 2.

FIG. 15 is a cut-away side view of the cement panel of FIG. 13 and template of FIGS. 1 and 2, wherein a counterbore hole has been formed.

FIG. 16 is a side view of the drill guide positioned proximate to the counterbore hole of FIGS. 14 and 15.

FIG. 17 is a side view of the cement panel fastened to the support member of FIG. 16.

FIG. 18 is a cut-away side view of the cement panel of FIG. 16 and template taken along a cut-line 5-5 of FIG. 2.

FIG. 19 is a cut-away side view of the cement panel and template of FIG. 18, wherein a counterbore hole has been formed.

FIG. 20 is a side view of the drill guide of FIG. 6 positioned proximate to the counterbore hole of FIGS. 18 and 19.

FIG. 21 is a side view of the cement panel of FIG. 20 fastened to the support member.

FIG. 22 is a perspective view of a spacer extension.

FIGS. 23 and 24 are top and end views of the spacer extension of FIG. 22.

FIG. 25 is a perspective view of another embodiment of a spacer extension.

FIGS. 26 and 27 are top and end views of the spacer extension of FIG. 25.

FIG. 28 is a close-up side view of the façade of FIG. 11, with the template of FIGS. 1 and 2 positioned thereon, and the spacer extension of FIG. 22, wherein the panel is to be coupled to the support member.

FIG. 29 is a close-up side view of the façade of FIG. 11, with the template of FIGS. 1 and 2 positioned thereon, and the spacer extension of FIG. 25, wherein the panel is to be coupled to the support member.

FIG. 30 is a close-up side view of the façade of FIG. 11, with the template of FIGS. 1 and 2 positioned thereon, and the spacer extensions of FIGS. 22 and 25, wherein the panel is to be coupled to the support member.

### DETAILED DESCRIPTION OF THE INVENTION

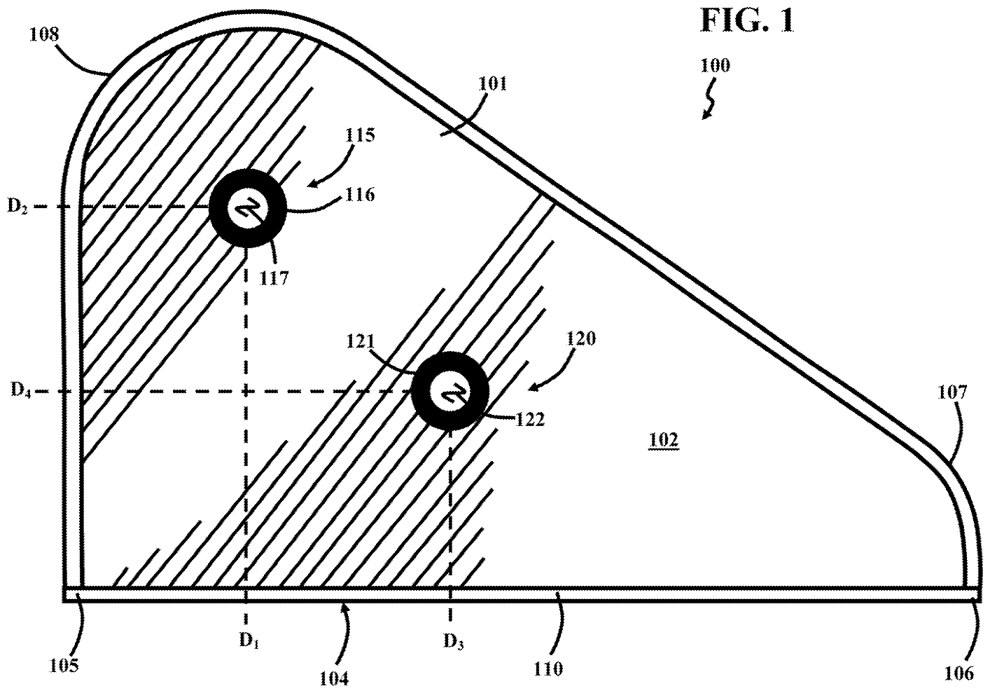

FIGS. 1 and 2 are top and bottom views, respectively, of a template 100. In this embodiment, the template 100 includes a template body 101, which has a first surface 102 and a second surface 103. The first and second surfaces 102 and 103 are opposed to each other. The template body 101 can have many different shapes, such as square, rectangular, triangular, and circular, among others. In this embodiment, the template body 101 includes at least one straight side, which is denoted as a side 104. The template 100 includes edged portions 105 and 106, which are proximate to opposed ends of the side 104. The template 100 includes a filleted portion 107 positioned proximate to the edged portion 106, and a filleted portion 108 positioned away from the edged portion 105. It should be noted that a filleted portion includes a curved surface portion. It should also be noted that the template body 101 can include many different types of materials, such as hardened plastic.

In general, the template 100 includes one or more countersink guide channels. In this embodiment, the template 100 includes a countersink guide channel 115. The countersink guide channel 115 includes a countersink guide channel ring 116, which extends between upper and lower countersink guide channel openings 117 and 118. The upper and lower countersink guide channel openings 117 and 118 are on opposed ends of the countersink guide channel 115. The upper and lower countersink guide channel openings 117 and 118 are proximate to the first and second surfaces 102 and 103, respectively.

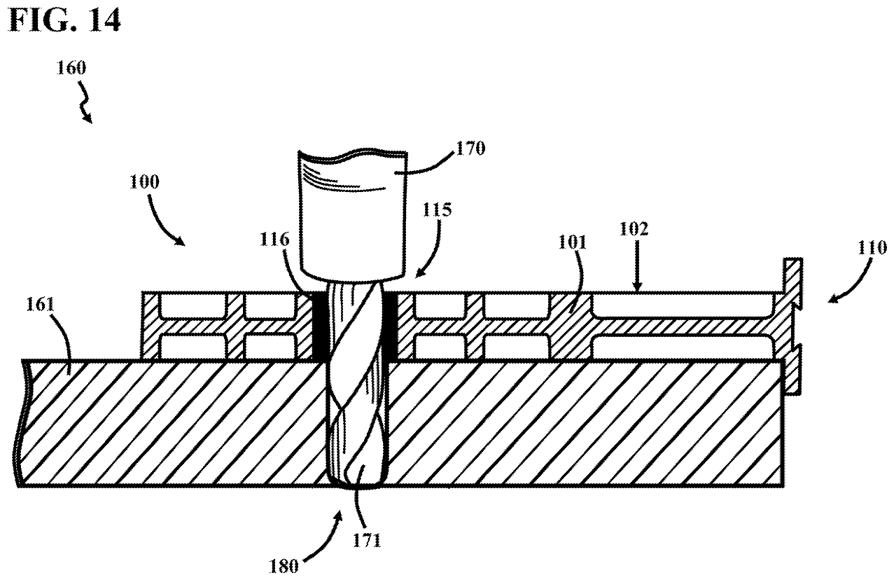

In general, the countersink guide channel ring 116 includes a first material which is harder than the material of the template body 101, such as a first metal. The material of the countersink guide channel ring 116 is resistant to being removed in response to being engaged by a first tool, such as a first drill bit. A first central channel extends through the countersink guide channel ring 117, wherein the first central channel is sized and shaped to receive the first drill bit for forming the first counterbore hole. The first drill bit will be discussed in more detail below with FIGS. 14, 15, 18, and 19, and is used to form a first counterbore hole.

In this embodiment, the template 100 includes a countersink guide channel 120. The countersink guide channel 120 includes a countersink guide channel ring 121, which extends between upper and lower countersink guide channel openings 122 and 123. The upper and lower countersink guide channel openings 122 and 123 are on opposed ends of the countersink guide channel 120. The upper and lower countersink guide channel openings 122 and 123 are proximate to the first and second surfaces 102 and 103, respectively.

In general, the countersink guide channel ring 121 includes a second material which is harder than the material of the template body 101, such as a second metal. The material of the countersink guide channel ring 121 is resistant to being removed in response to being engaged by a second tool, such as a second drill bit. A second central channel extends through the countersink guide channel ring 121, wherein the second central channel is sized and shaped to receive the second drill bit for forming the second counterbore hole. The second drill bit will be discussed in more detail below with FIGS. 14, 15, 18, and 19, and is used to form a second counterbore hole.

It should be noted that the first and second metals can be the same metals or different metals. Further, it should be noted that the first and second drill bits can be the same drill bits or different drill bits, wherein the first and second drill bits are coupled to a drill in a well-known manner. The size of the first and second central channels of the corresponding countersink guide channel rings 116 and 121 are generally the same when the first and second drill bits are the same size. The size of the first and second central channels of the corresponding countersink guide channel rings 116 and 121 are generally different when the first and second drill bits are different sizes.

The countersink guide channel 115 is spaced a distance D₁ from the edged portion 105 towards the edged portion 106, and the countersink guide channel 115 is spaced a distance D₂ from the edged portion 105 towards the filleted portion 108. The countersink guide channel 120 is spaced a distance D₃ from the edged portion 105 towards the edged portion 106, and the countersink guide channel 120 is spaced a distance D₄ from the edged portion 105 towards the filleted portion 108. In one particular embodiment, the distance D₁ is 40 mm, the distance D₂ is 80 mm, the distance D₃ is 80 mm, and the distance D₄ is 40 mm.

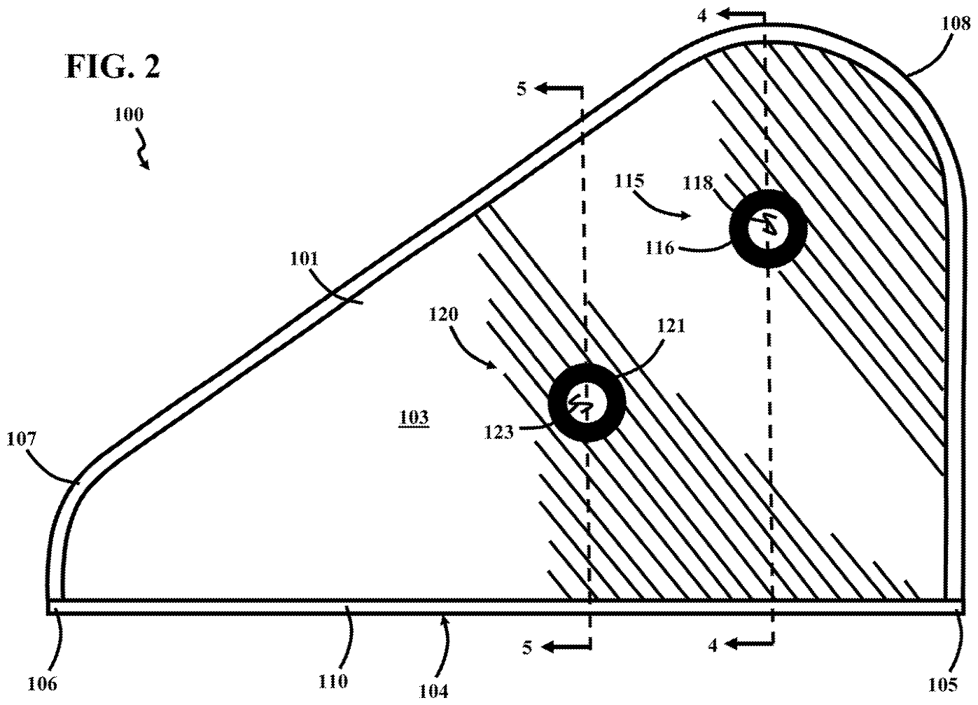

FIG. 3 is a side view of the template 100 of FIGS. 1 and 2. As mentioned above, the template 100 includes the guide portion 110. In this embodiment, the guide portion 110 includes an upper guide portion 111, which extends away from the first surface 102, and a lower guide portion 112, which extends away from the second surface 103. The upper and lower guide portions 111 and 112 extend in opposed directions. The guide portion 110 includes a guide portion slot 113, which extends between the upper and lower guide portions 111 and 112. More information regarding the upper and lower guide portions 111 and 112, and the guide portion slot 113 will be provided below.

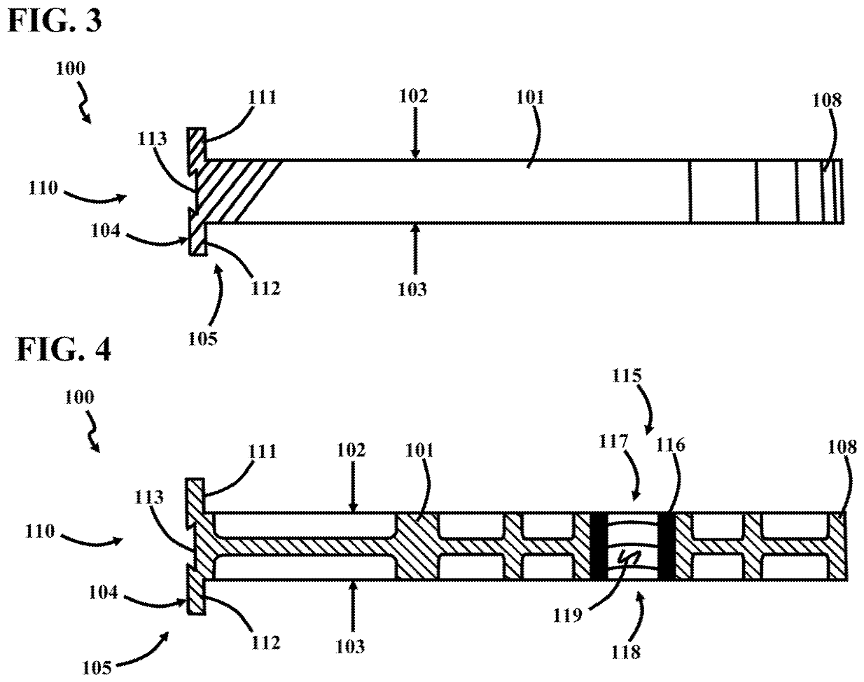

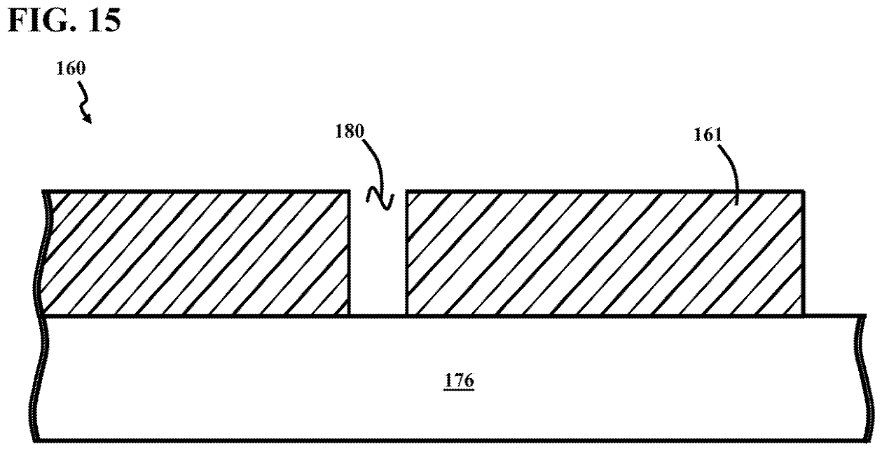

FIG. 4 is a cut-away side view of the template 100 of FIGS. 1 and 2 taken along a cut-line 4-4 of FIG. 2. As can be seen, the countersink guide channel 115 extends between the first and second surfaces 102 and 103. Further, the countersink guide channel ring 616 extends between the first and second surfaces 102 and 103. The countersink guide channel ring 116 includes a central channel 119, wherein the central channel 119 is sized and shaped to receive the first tool for forming a first counterbore hole. The formation of the first counterbore hole will be discussed in more detail below with FIGS. 14 and 15.

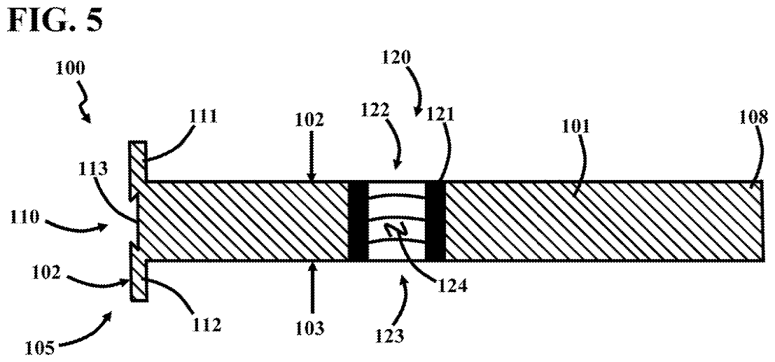

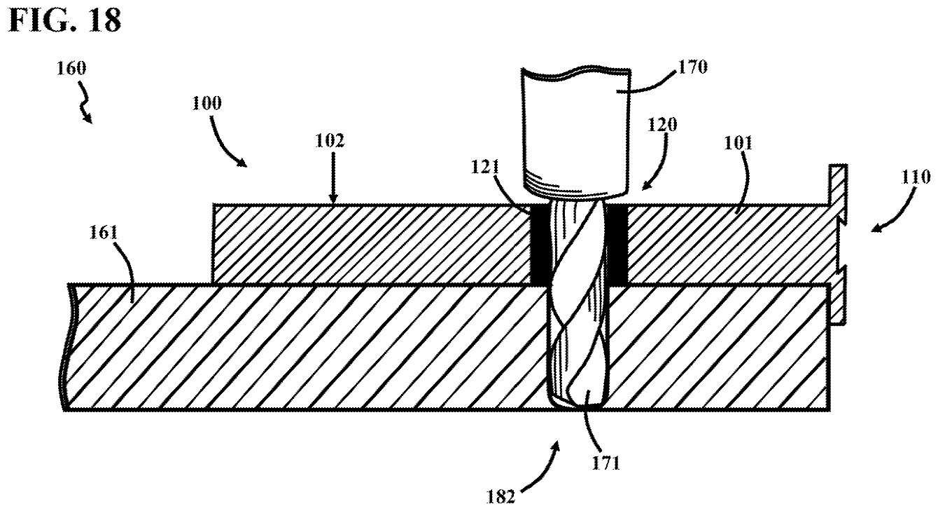

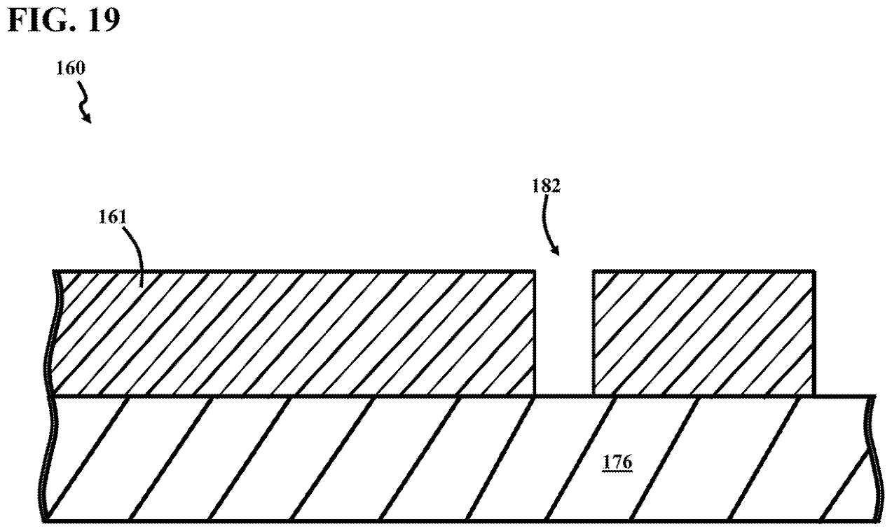

FIG. 5 is a cut-away side view of the template 100 of FIGS. 1 and 2 taken along a cut-line 5-5 of FIG. 2. As can be seen, the countersink guide channel 120 extends between the first and second surfaces 102 and 103. Further, the countersink guide channel ring 121 extends between the first and second surfaces 102 and 103. The countersink guide channel ring 121 includes a central channel 124, wherein the central channel 124 is sized and shaped to receive the second tool for forming a second counterbore hole. The formation of the second counterbore hole will be discussed in more detail below with FIGS. 18 and 19.

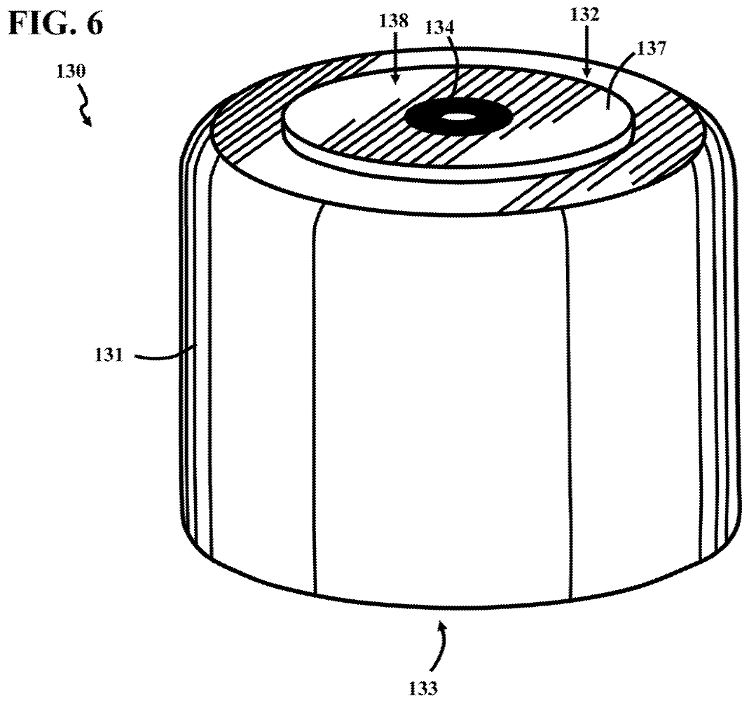

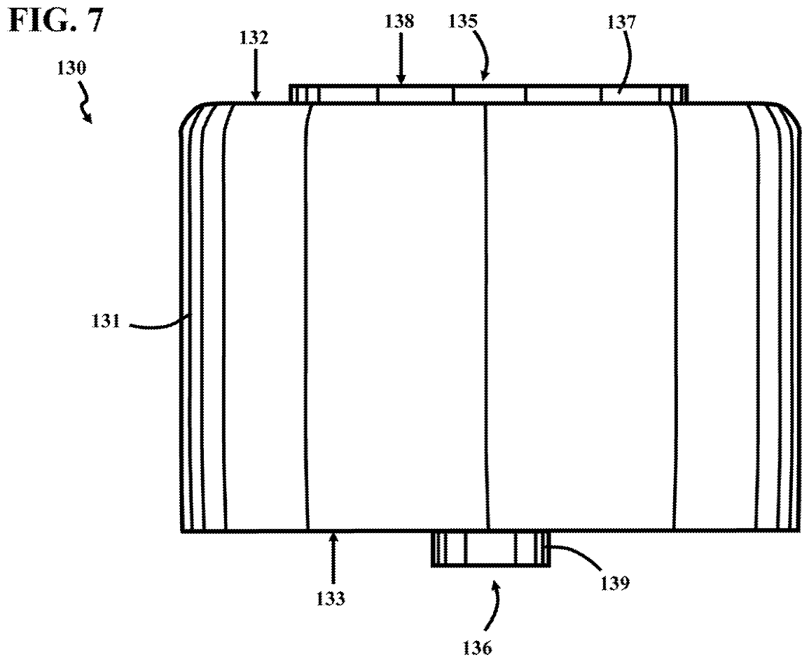

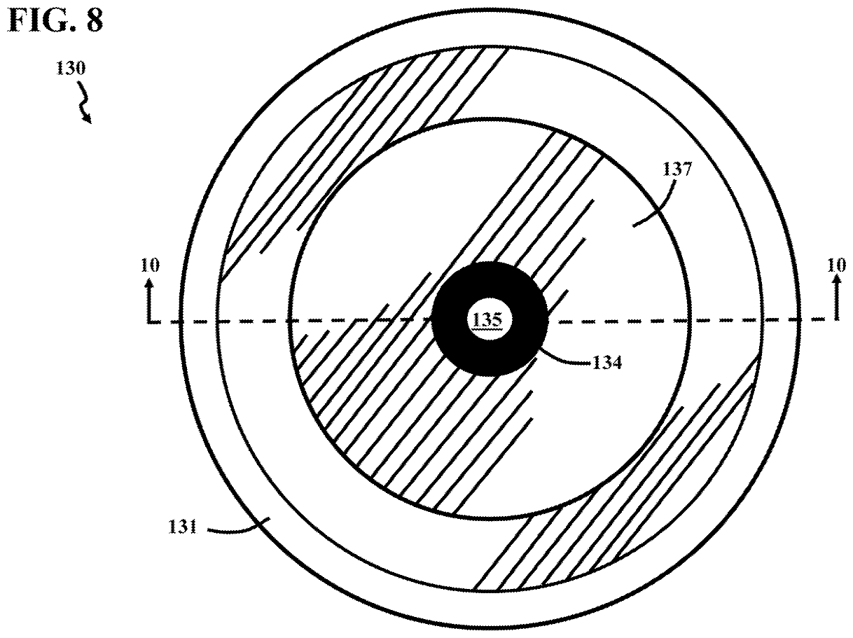

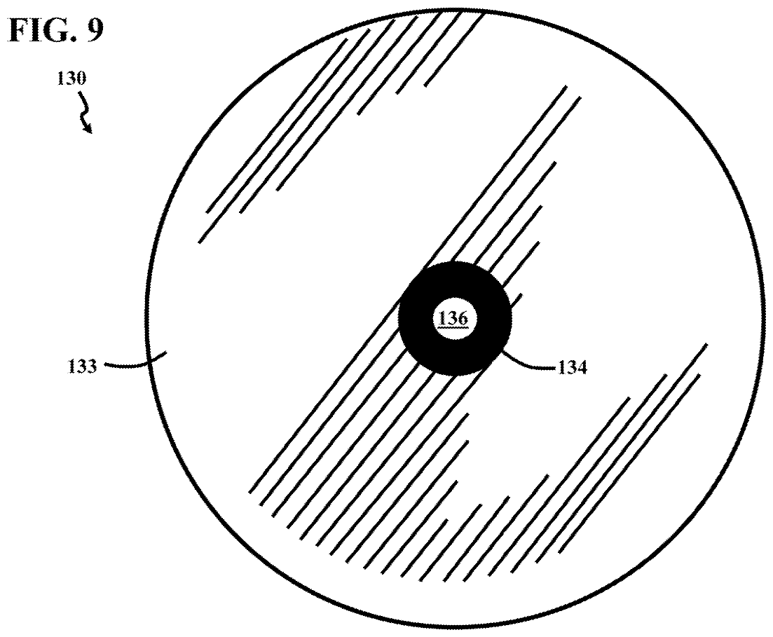

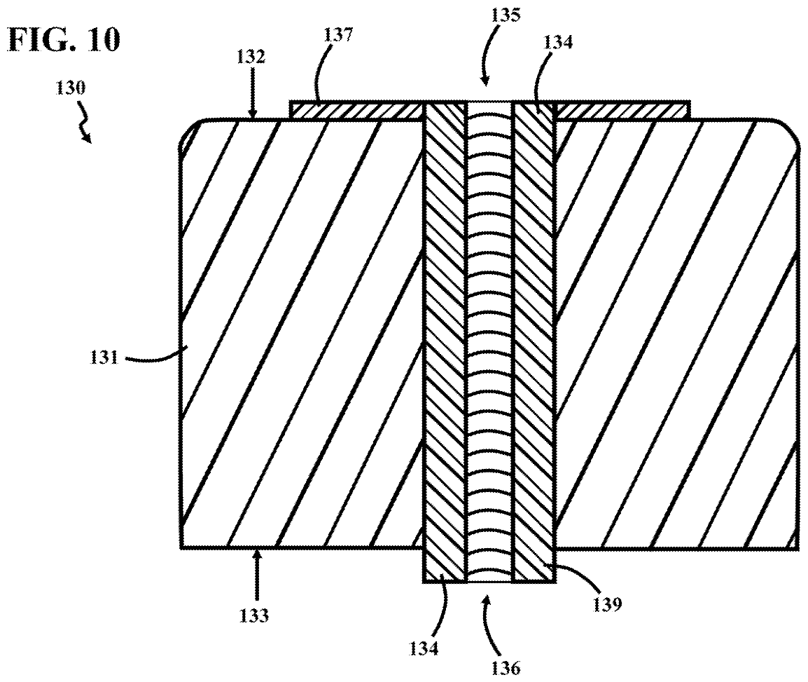

FIG. 6 is a perspective view of a drill guide 130, and FIG. 7 is a side view of the drill guide 130 of FIG. 6. FIGS. 8 and 9 are top and bottom views, respectively, of the drill guide 130 of FIG. 6. FIG. 10 is a cut-away side view of the drill guide 130 of FIG. 6 taken along a cut-line 10-10 of FIG. 8.

In this embodiment, the drill guide 130 includes a drill guide body 131, with an upper surface 132 and lower surface 133. The upper and lower surfaces 132 and 133 are opposed to each other. The drill guide 130 includes a ring 137 positioned on the upper surface 132. A drill guide channel ring 134 extends through a central opening of the ring 137, and through the upper and lower surfaces 132 and 133 (FIG. 10). The drill guide channel ring 134 extends through the drill guide body 131. A portion 139 of the drill guide channel ring 134 extends away from the lower surface 133, as shown in FIGS. 7 and 10.

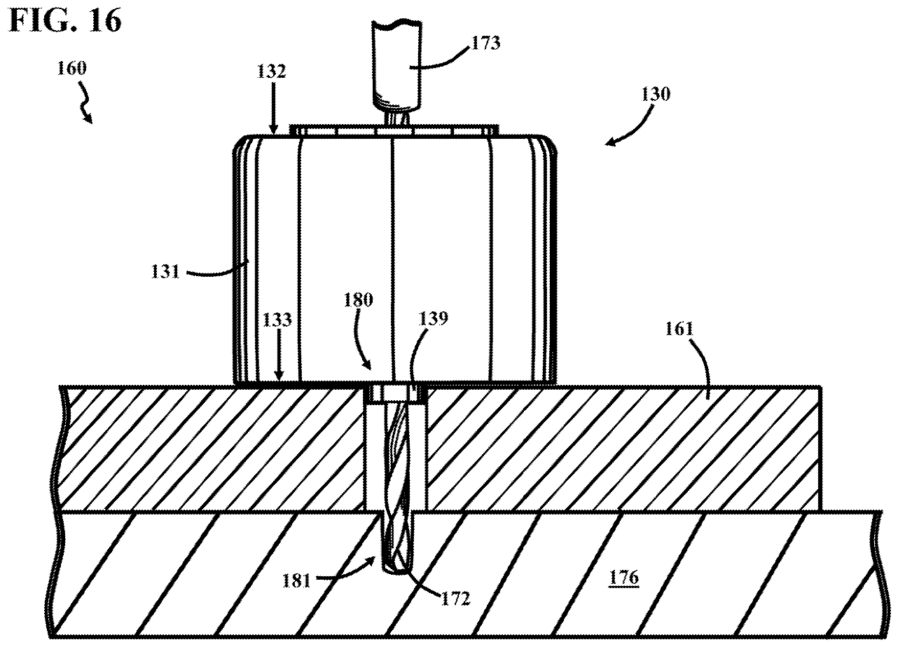

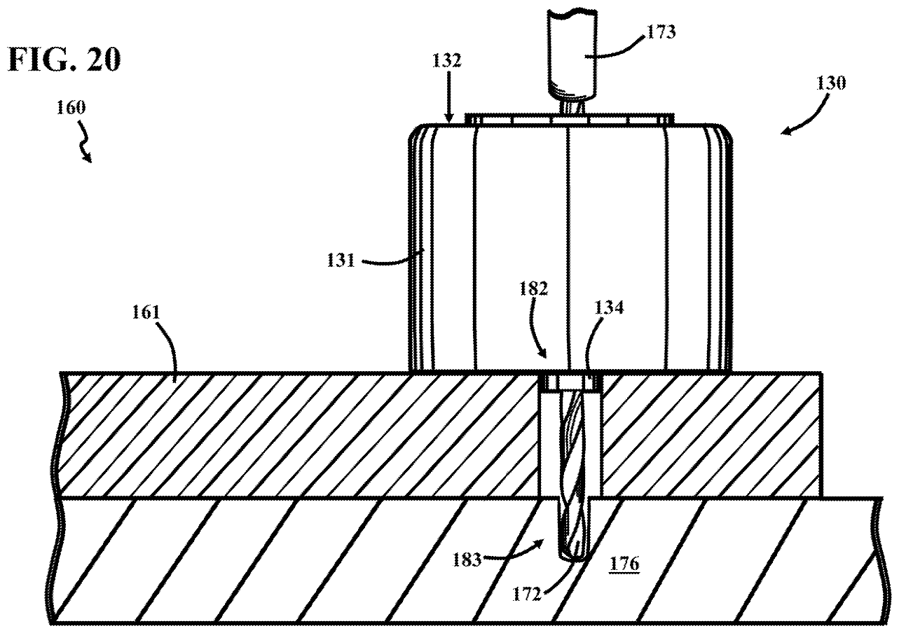

It should be noted that the drill guide body 131 can include many different types of materials, such as hardened plastic. In general, the drill guide channel ring 134 includes a material which is harder than the material of the drill guide body 131, such as metal. The material of the drill guide body 131 is resistant to being removed in response to being engaged by a third tool, such as a third drill bit. The third drill bit will be discussed in more detail below with FIGS. 16 and 20, and is used to form a pilot hole. It should be noted that the third tool can be a drill which carries the third drill bit in a well-known manner. The drill can be the same drill mentioned above, which carries the first and second drill bits.

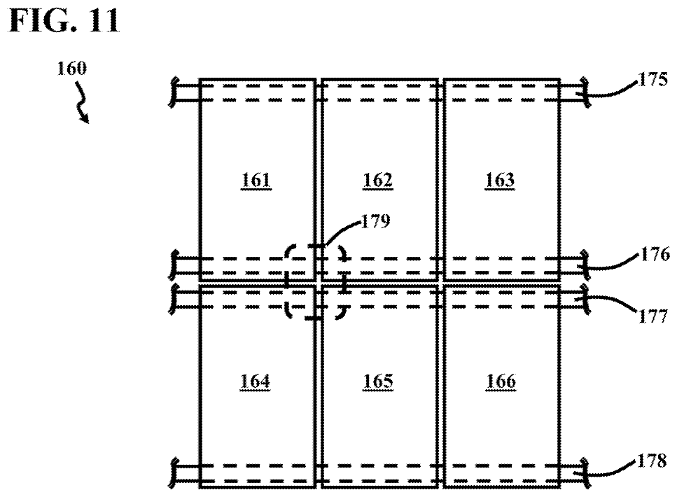

FIG. 11 is a top view of a façade 160. The façade can be of many different types. In this embodiment, the façade 160 includes a panel. In general, the façade 160 includes one or more panels. In this embodiment, the façade 160 includes panels 161, 162, 163, 164, 165, and 166. The façade 160 includes a support member which supports a panel thereof. In general, the façade 160 includes one or more support members. In this embodiment, the façade 160 includes a support member 175, which engages the panels 161, 162, and 163. Further, the façade 160 includes a support member 176, which engages the panels 161, 162, and 163. In this embodiment, the façade 160 includes a support member 177, which engages the panels 164, 165, and 166. Further, the façade 160 includes a support member 178, which engages the panels 164, 165, and 166.

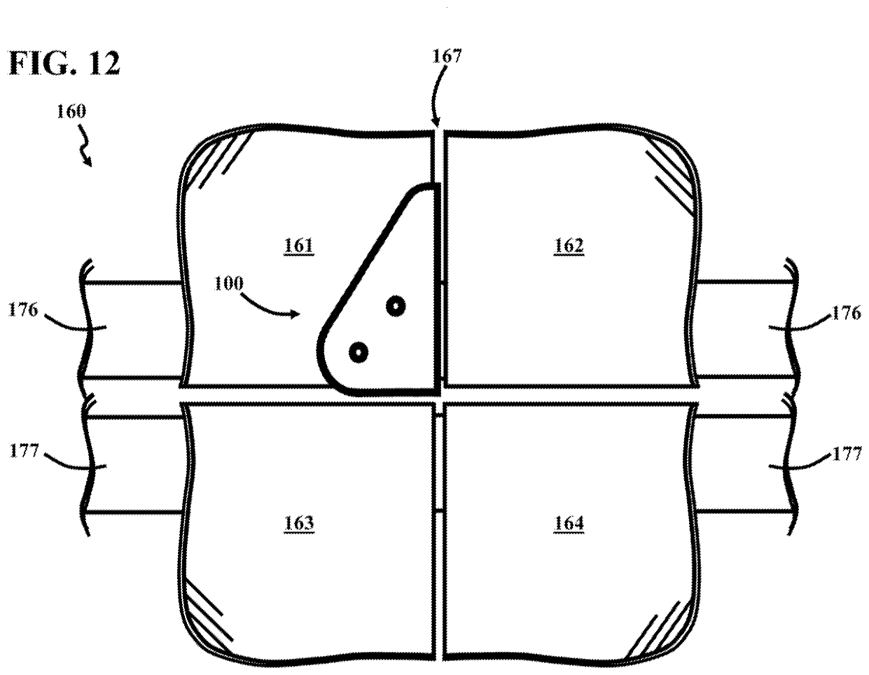

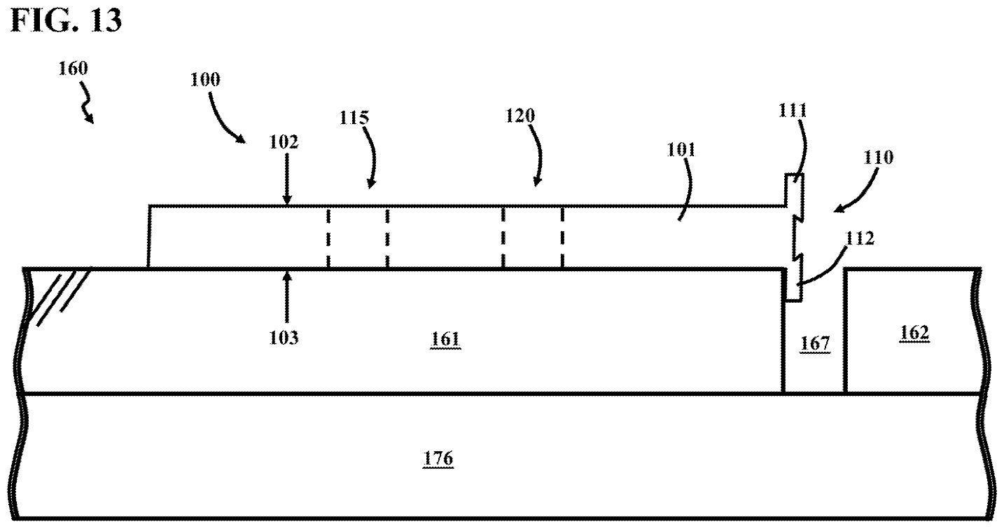

FIG. 12 is a close-up view of the façade 100 of FIG. 11 showing the template 100 in a region 179, FIG. 13 is a close-up side view of the façade 160 of FIG. 11, with the template 100 positioned thereon, wherein the panel 161 is to be coupled to the support member 176. In this embodiment, the second surface 103 engages the panel 176, and the first surface 102 is away from the panel 161. It should be noted that the template 100 can be positioned so the first surface engages the panel 161, and the second surface 103 is away from the panel 161, if desired.

In this embodiment, a gap 167 extends between the panels 161 and 162. The template 100 is engaged with the panel 161, and the guide portion 110 extends through the gap 167 (FIG. 13). In particular, the lower guide portion 112 engages the panel 161 and extends through the gap 167. The upper guide portion Ill extends away from the panel 161 and gap 167. As will be discussed in more detail presently, it is desirable to fasten the panel 161 to the support member 176.

FIG. 14 is a cut-away side view of the cement panel 161 and template 100 taken along the cut-line 4-4 of FIG. 2, and FIG. 15 is a cut-away side view of the cement panel 100 and template 100, wherein the counterbore hole 180 has been formed. In this embodiment, the template 100 is positioned as shown and described in FIG. 13. The first tool, such as the first drill bit, is positioned proximate to the template 100. In this embodiment, the first tool is embodied as a first power drill, which includes a counterbore drill bit 171 carried by a drill chuck 170. The counterbore drill bit 171 is aligned with the countersink guide channel ring 116, and extended therethrough to form a counterbore hole 180. The counterbore hole 180 extends through opposed surfaces of the panel 161. As shown in FIG. 15, the panel 161 is positioned against the support member 176.

FIG. 16 is a side view of the drill guide 130 positioned proximate to the counterbore hole 180 of FIGS. 14 and 15. In this embodiment, the drill guide 130 is positioned proximate to the counterbore hole 180 so the portion 139 of the drill guide channel ring 134 extends therethrough, and the surface 133 engages the panel 161, the second tool, such as the second drill bit, is positioned proximate to the drill guide 130. In this embodiment, the second tool is embodied as a second power drill, which includes a pilot hole drill bit 172 carried by a drill chuck 173. It should be noted that the first and second tools can be the same tools. The pilot hole drill bit 172 is aligned with the upper countersink guide channel opening 135, and extended through the lower countersink guide channel opening 136. The pilot hole drill bit 172 is extended through the counterbore hole 180 to the support member 176, wherein a pilot hole 181 is formed therein. It should be noted that the drill guide 130 positions the pilot hole drill bit 172 substantially in the center of the counterbore hole 180. In this way, the pilot hole 181 is formed aligned substantially in the center of the counterbore hole 180. In this embodiment, the pilot hole 181 is partially formed through the support member 176. However, in some situations, the pilot hole 181 is formed through the support member 176, if desired.

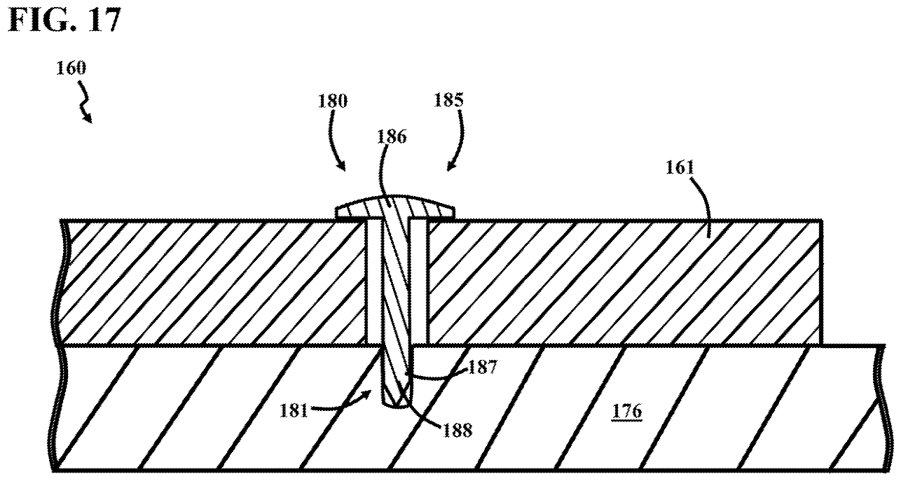

FIG. 17 is a side view of the cement panel 161 fastened to the support member 176. In this embodiment, the drill guide 130 has been moved away from the panel 161. A fastener 185 is used to fasten the panel 161 and support member 176 together. In this embodiment, the fastener 185 includes a head 186 with a shaft 187 extending therefrom. In some embodiments, the shaft 187 includes a threaded portion 188. The fastener 185 is positioned so the shaft 187 extends through the counterbore hole 180 and frictionally engages the pilot hole 181. It should be noted that, in this embodiment, the threaded portion 188 threadingly engages the support member 176 proximate to the pilot hole 181. In particular, the threaded portion 188 threadingly engages the support member 176 in response to being extended through the pilot hole 181. It should be noted that the shaft 187 is positions substantially in the center of the counterbore hole 180. In this way, the shaft 187 is less likely to engage the outer periphery of the counterbore hole 180. As mentioned above, the panel 161 experiences undesirable stress in response to expansion and contraction, and the undesirable stress increases in response to the shaft 187 engaging the panel 161.

FIG. 18 is a cut-away side view of the cement panel 161 and template 100 taken along a cut-line 5-5 of FIG. 2, and FIG. 19 is a cut-away side view of the cement panel 100 and template 100, wherein the counterbore hole 182 has been formed. In this embodiment, the template 100 is positioned as shown and described in FIG. 13. The first tool, such as the first drill, is positioned proximate to the template 100. In this embodiment, the first tool is embodied as the first power drill, which includes the counterbore drill bit 171 carried by the drill chuck 170. The counterbore drill bit 171 is aligned with the countersink guide channel ring 116, and extended therethrough to form a counterbore hole 182. The counterbore hole 182 extends through opposed surfaces of the panel 161. As shown in FIG. 19, the panel 161 is positioned against the support member 176.

FIG. 20 is a side view of the drill guide 130 positioned proximate to the counterbore hole 180 of FIGS. 18 and 19. In this embodiment, the drill guide 130 is positioned proximate to the counterbore hole 182 so the portion 139 of the drill guide channel ring 134 extends therethrough, and the surface 133 engages the panel 161. The second tool, such as the second drill, is positioned proximate to the drill guide 130. In this embodiment, the second tool is embodied as the second power drill, which includes the pilot hole drill bit 172 carried by the drill chuck 173. It should be noted that the first and second tools can be the same tools. The pilot hole drill bit 172 is aligned with the upper countersink guide channel opening 135, and extended through the lower countersink guide channel opening 136. The pilot hole drill bit 172 is extended through the counterbore hole 182 to the support member 176, wherein a pilot hole 183 is formed therein. It should be noted that the drill guide 130 positions the pilot hole drill bit 172 substantially in the center of the counterbore hole 182. In this way, the pilot hole 183 is formed aligned substantially in the center of the counterbore hole 182. In this embodiment, the pilot hole 183 is partially formed through the support member 176. However, in some situations, the pilot hole 183 is formed through the support member 176, if desired.

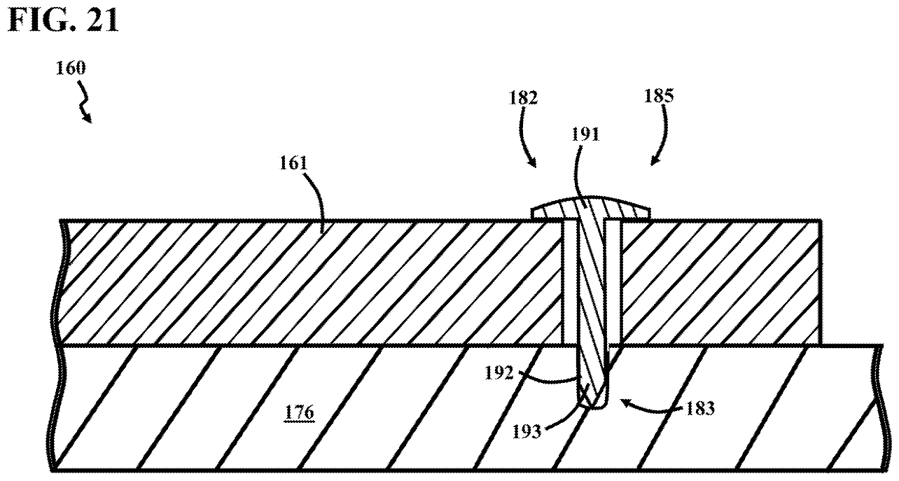

FIG. 21 is a side view of the cement panel 161 fastened to the support member 176. In this embodiment, the drill guide 130 has been moved away from the panel 161. The fastener 185 is used to fasten the panel 161 and support member 176 together. In this embodiment, the fastener 185 includes the head 186 with the shaft 187 extending therefrom. In some embodiments, the shaft 187 includes the threaded portion 188. The fastener 185 is positioned so the shaft 187 extends through the counterbore hole 182 and frictionally engages the pilot hole 183. It should be noted that, in this embodiment, the threaded portion 188 threadingly engages the support member 176 proximate to the pilot hole 183. In particular, the threaded portion 188 threadingly engages the support member 176 in response to being extended through the pilot hole 183. It should be noted that the shaft 187 is positions substantially in the center of the counterbore hole 182. In this way, the shaft 187 is less likely to engage the outer periphery of the counterbore hole 182. As mentioned above, the panel 161 experiences undesirable stress in response to expansion and contraction, and the undesirable stress increases in response to the shaft 187 engaging the panel 161.

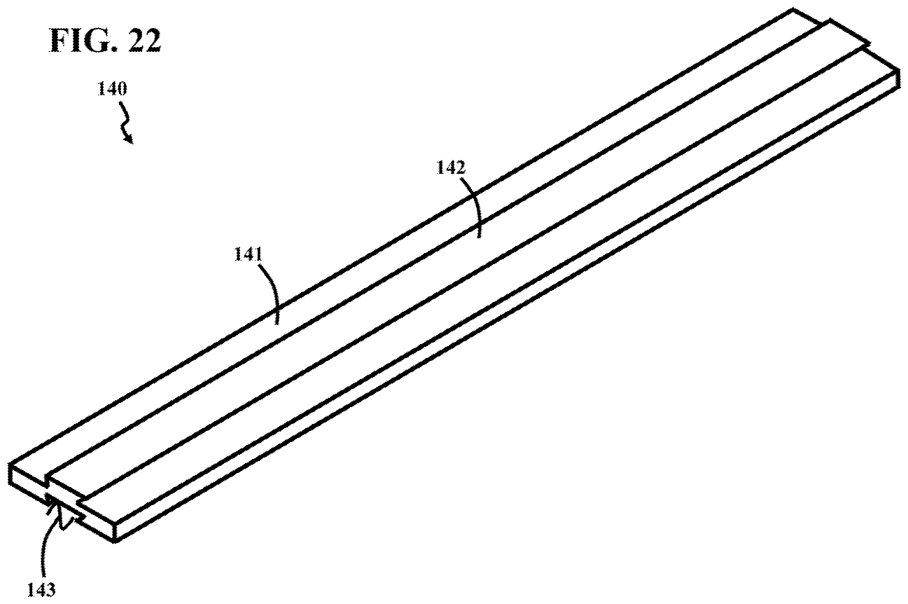

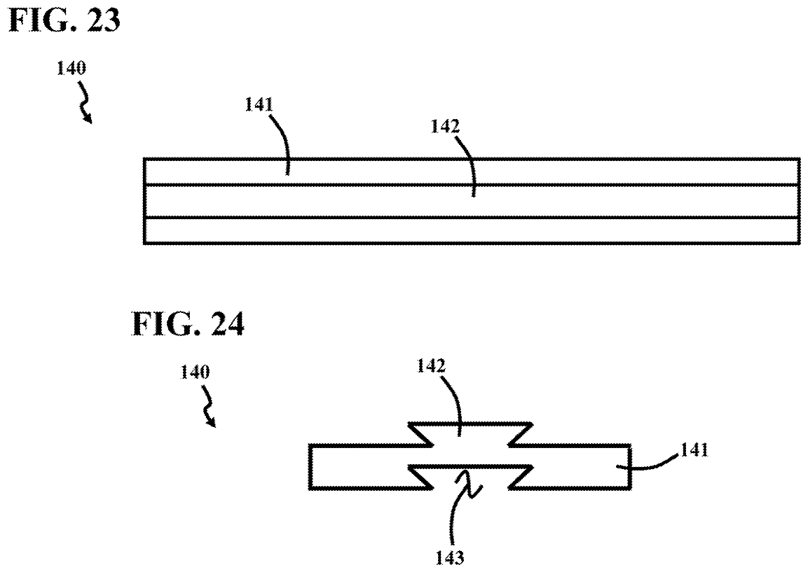

FIG. 22 is a perspective view of a spacer extension 140, and FIGS. 23 and 24 are top and end views of the spacer extension 140 of FIG. 22. In this embodiment, the spacer 140 includes a spacer body 141, with a spacer protrusion 142 extending therefrom. The spacer protrusion 142 is sized and shaped to be received by the guide portion slot 113, which is shown in FIGS. 3, 4, and 5. The spacer protrusion 142 can be slidingly engaged with the guide portion 110 by extending it through the guide portion slot 113. The spacer protrusion 142 can be slidingly disengaged with the guide portion 110 by moving it away from the guide portion slot 113. In this way, the spacer extension 140 can be carried by the template 100 in a repeatably removeable manner. In this embodiment, the spacer extension 140 includes a spacer slot 143 for receiving the spacer protrusion of another spacer extension. In this way, a number of spacers can be chosen to provide a desired thickness.

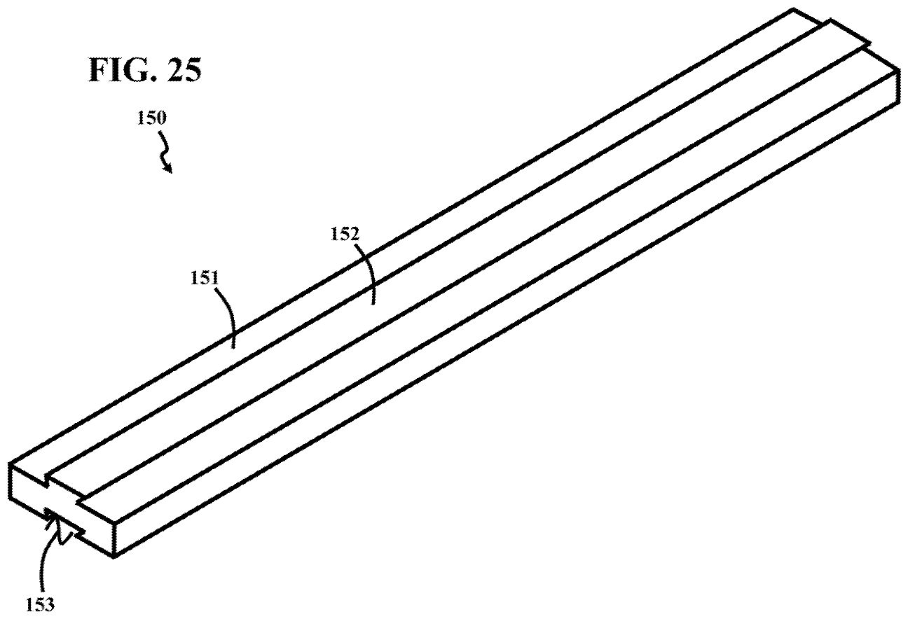

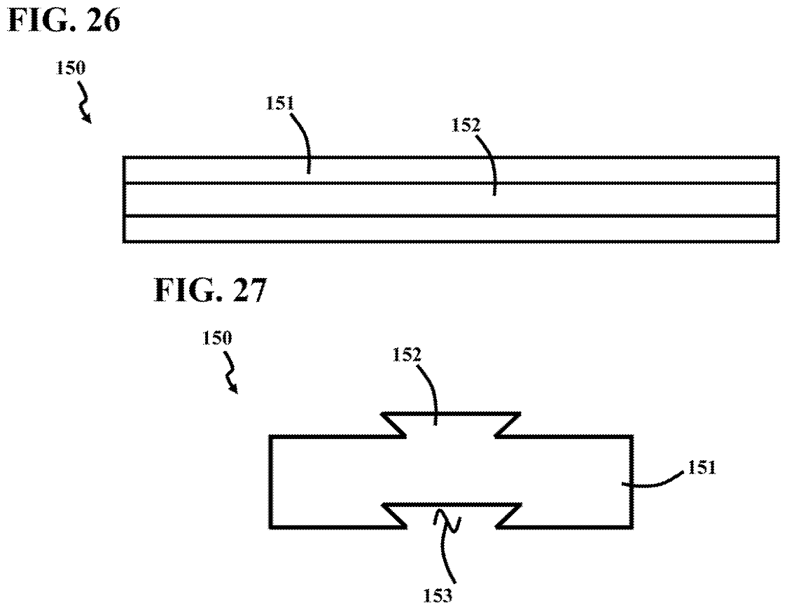

FIG. 25 is a perspective view of a spacer extension 150, and FIGS. 26 and 27 are top and end views of the spacer extension 150 of FIG. 25. In this embodiment, the spacer 150 includes a spacer body 151, with a spacer protrusion 152 extending therefrom. The spacer protrusion 152 is sized and shaped to be received by the guide portion slot 113, which is shown in FIGS. 3, 4, and 5. The spacer protrusion 152 can be slidingly engaged with the guide portion 110 by extending it through the guide portion slot 113. The spacer protrusion 152 can be slidingly disengaged with the guide portion 110 by moving it away from the guide portion slot 113. In this way, the spacer extension 150 can be carried by the template 100 in a repeatably removeable manner. In this embodiment, the spacer extension 150 includes a spacer slot 153 for receiving the spacer protrusion of another spacer extension. In this way, a number of spacers can be chosen to provide a desired thickness.

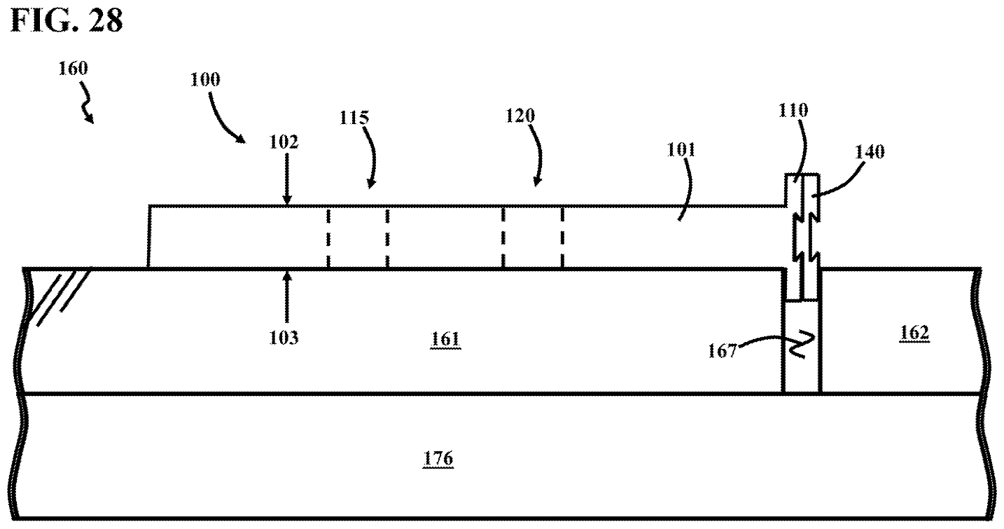

FIG. 28 is a close-up side view of the façade 160 of FIG. 11, with the template 100 positioned thereon, wherein the panel 161 is to be coupled to the support member 176. In this embodiment, the template 100 carries the spacer extension 140. The template 100 can carry the spacer extension 140 in many different ways. In this embodiment, the spacer protrusion 142 is extended through the guide portion slot 113 (FIGS. 3 and 4) so the spacer extension 140 extends through the gap 167. In this embodiment, the spacer extension 140 engages the panel 162 so that the guide portions 110 and spacer body 141 span the gap 167.

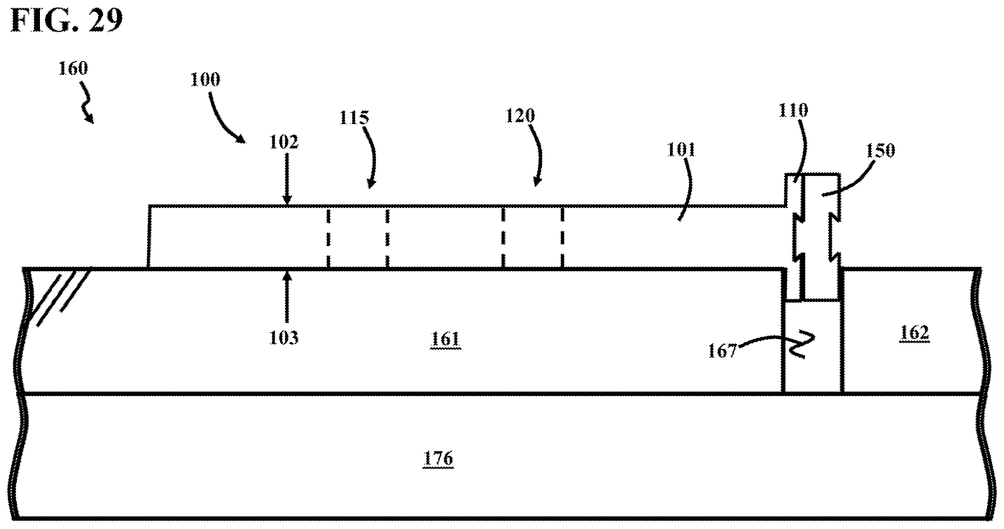

FIG. 29 is a close-up side view of the façade 160 of FIG. 11, with the template 100 positioned thereon, wherein the panel 161 is to be coupled to the support member 176. In this embodiment, the template 100 carries the spacer extension 150. The template 100 can carry the spacer extension 150 in many different ways. In this embodiment, the spacer protrusion 152 is extended through the guide portion slot 113 (FIGS. 3 and 4) so the spacer extension 150 extends through the gap 167. In this embodiment, the spacer extension 150 engages the panel 162 so that the guide portions 110 and spacer body 151 span the gap 167.

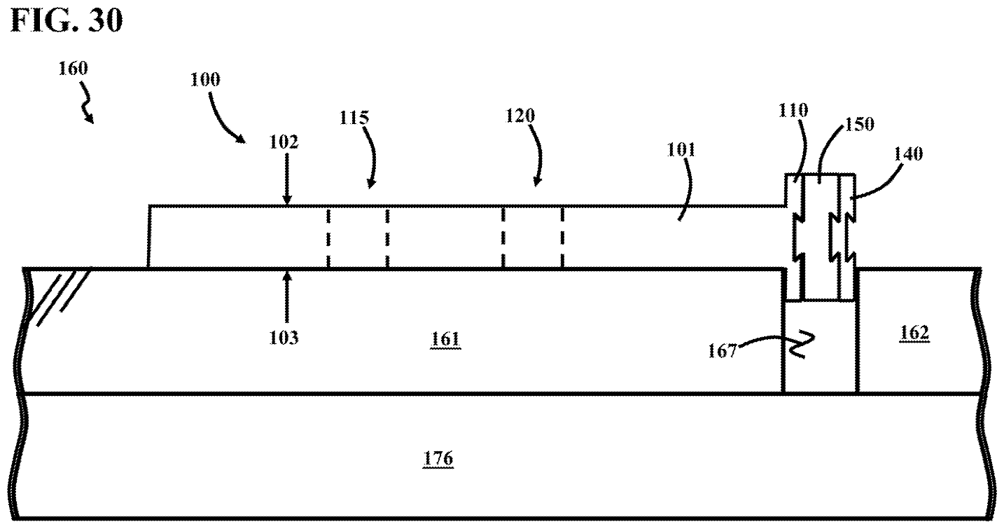

FIG. 30 is a close-up side view of the façade 160 of FIG. 11, with the template 100 positioned thereon, wherein the panel 161 is to be coupled to the support member 176. In this embodiment, the template 100 carries the spacer extension 140. The template 100 can carry the spacer extension 140 in many different ways. In this embodiment, the spacer protrusion 142 is extended through the guide portion slot 113 (FIGS. 3 and 4) so the spacer extension 140 extends through the gap 167. In this embodiment, the spacer extension 140 carries the spacer extension 150. The spacer extension 140 can carry the spacer extension 150 in many different ways. In this embodiment, the spacer protrusion 152 is extended through the spacer slot 143 so the spacer extension 150 extends through the gap 167. In this embodiment, the spacer extension 150 engages the panel 162 so that the guide portions 110 and spacer bodies 141 and 151 span the gap 167.

It should be noted that the gap 167 in FIG. 28 is smaller than the gap 167 in FIG. 29, and the gap 167 in FIG. 29 is smaller than the gap 167 in FIG. 30. Further, the gap 167 in FIG. 30 is larger than the gap 167 in FIG. 29, and the gap 167 in FIG. 29 is larger than the gap 167 in FIG. 28.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A template, comprising:
a template body 101 with a guide portion 110 wherein the guide portion 110 includes upper 111 and lower 112 guide portions, and a guide portion slot 113;
wherein the template body 101 includes a first countersink guide channel 115 having a first countersink guide channel ring 116 extending therethrough, the material of the first countersink guide channel ring 116 being harder than the material of the template body 101.

2. The template of claim 1, wherein the first countersink guide channel ring 116 extends between opposed surfaces of the template body.

3. The template of claim 1, further including a second countersink guide channel 120 having a second countersink guide channel ring 121 extending therethrough, the material of the second countersink guide channel ring 121 being harder than the material of the template body 101.

4. The template of claim 3, wherein the second countersink guide channel ring 121 extends between opposed surfaces of the template body.

5. The template of claim 1, wherein the template body 101 includes a filleted portion 107.

6. The template of claim 5, wherein the guide portion 110 extends between first and second edged portions 105 and 106, the filleted portion 107 being positioned proximate to the first edged portion 106.

7. The template of claim 7, wherein the guide portion slot 113 extends between the upper 111 and lower 112 guide portions.

8. An apparatus, comprising:
a template body 101 with a guide portion 110 wherein the guide portion 110 includes upper 111 and lower 112 guide portions, and a guide portion slot 113;
wherein the guide portion slot 113 is sized and shaped to receive a spacer;
wherein the template body 101 includes a first countersink guide channel 115 having a first countersink guide channel ring 116 extending therethrough.

9. The apparatus of claim 8, further including a second countersink guide channel 120 having a second countersink guide channel ring 121 extending therethrough, the material of the second countersink guide channel ring 121 being harder than the material of the template body 101.

10. The apparatus of claim 8, further including a first spacer coupled to the guide portion slot 113 in a repeatably removeable manner.

11. The apparatus of claim 10, wherein the first spacer includes a first spacer protrusion which is sized and shaped to extend through the guide portion slot 113.

12. The apparatus of claim 11, further including a second spacer coupled to the first spacer.

13. The template of claim 12, wherein the first spacer includes a first spacer slot and the second spacer includes a second spacer protrusion, wherein the second spacer protrusion extends through the first spacer slot.

14. The apparatus of claim 13, wherein the first and second spacers are of different sizes.

15. An apparatus, comprising:
a template body 101 with a guide portion 110 wherein the guide portion 110 includes upper 111 and lower 112 guide portions, and a guide portion slot 113;
wherein the template body 101 includes a first countersink guide channel 115 having a first countersink guide channel ring 116 extending therethrough, the material of the first countersink guide channel ring 116 being harder than the material of the template body 101;
wherein the template body 101 includes a second countersink guide channel 120 having a second countersink guide channel ring 121 extending therethrough, the material of the second countersink guide channel ring 121 being harder than the material of the template body 101.

16. The template of claim 15, wherein the first and second countersink guide channel rings 116 and 121 extend between opposed surfaces of the template body.

17. The template of claim 15, wherein the guide portion slot 113 extends between the upper 111 and lower 112 guide portions.

18. The apparatus of claim 17, further including a first spacer coupled to the guide portion slot 113 in a repeatably removeable manner.

19. The apparatus of claim 18, wherein the first spacer includes a first spacer protrusion which is sized and shaped to extend through the guide portion slot 113.

20. The apparatus of claim 19, further including a second spacer coupled to the first spacer.
